(19) United States
(12) Patent Application Publication
(10) Pub. No.: US 2026/0087346 A1
(43) Pub. Date: Mar. 26, 2026

(54) TARGETED GENERATIVE PRE-TRAINED TRANSFORMERS ("GPTs")

(71) Applicant: Bank of America Corporation, Charlotte, NC (US)

(72) Inventors: Saurabh Mavani, Lake Hopatcong, NJ (US); Manu Kurian, Dallas, TX (US)

(21) Appl. No.: 18/894,184

(22) Filed: Sep. 24, 2024

(51) Int. Cl. G06N 3/082; G06N 3/045

(52) U.S. Cl. CPC G06N 3/082; G06N 3/045

(57) ABSTRACT

A system for creating a targeted model is provided. The system may include a processor. The processor may receive a pre-trained model including a plurality of weighted neurons organized within a plurality of layers. The processor may receive an instruction to prune the pre-trained model for a predetermined discipline. The processor may identify a first set of training data elements corresponding to the discipline. The processor may freeze the weights of the neurons of the pre-trained model. The processor may disable the first set of training data elements from changing the weights of the neurons. The processor may process the first set of training data elements through the pre-trained model. During processing the first set of training data elements, the processor may highlight a subset of affected neurons. The processor may create a targeted model for the discipline. The targeted model may include the highlighted neurons and associated weights.

### FIELD OF TECHNOLOGY

Aspects of the disclosure relate to artificial intelligence.

### BACKGROUND OF THE DISCLOSURE

Recently, there has been an increase in the use of large language models. Large language models are neural networks trained on a large amount of data. The data on which the large language models are trained is typically harvested from public sources, such as the Internet.

Large language models may be structured in different architectures. One of the architectures used to structure a large language model is a transformer architecture. A transformer architecture enables large language models to analyze and predict text.

Typical transformer architecture involves the following steps. Firstly, the transformer architecture converts text to numerical representations. The numerical representations are referred to as tokens. Secondly, each token is converted to a vector. The conversion involves looking up the token in a word embedding table. Thirdly, a parallel multi-head attention mechanism contextualizes each token within the scope of a context window. The context window involves other tokens. The contextualization allows a signal for key tokens to be amplified and less important tokens to be diminished. Assigning an importance metric to each token (and associated word) in a sentence enables the large language model to accurately process and predict text.

Large language models may be used in a variety of disciplines. Large language models may be used to generate text, automate tasks and classify images. Large language models are typically one size fits all models. As such, the large language models may be suitable for performing a variety tasks, such as the aforementioned tasks. However, specifically because the large language models are capable of performing a variety of tasks, the large language models may not be excellent at performing any of those tasks.

Therefore, it would be desirable to create small language models. Such small language models may also be referred to as targeted generative pre-trained transformers (“GPTs”). Such small language models may be trained on entity-specific documents and/or content.

It would be desirable to implement small language models to focus interactions between an entity and a client. Such a small language model may be trained on the entity-specific documents and/or content. It would be further desirable for the entity-specific documents and/or content to include direction regarding what a client is currently requesting. It would be yet further desirable for the entity-specific documents and/or content to include direction regarding what a customer is considering.

### SUMMARY OF THE DISCLOSURE

Apparatus, systems and methods for creating and operating targeted generative pre-trained transformers (“GPTs”) is provided. Targeted GPTs may also be referred to as small language models.

A small language model may be customized for one or more use cases. A small language model may be customized for each client of an entity. An example of a small language model may include a customized language model regarding student loan information for a student client. Another example of a small language model may include a customized language model regarding car loan information for a graduate client. Yet another example of a small language model may include a customized language model regarding pre-created briefing for a new client review. Still another example of a small language model may include a customized language model regarding pre-retirement documents for a potential retiree client. The small language models or targeted GPTs may be based on content that is already owned and/or accessible by the entity.

The targeted GPTs may pre-generate content based on predictive behavior patterns. As such, such targeted GPTs may involve predictive artificial intelligence (“AI”) architecture in addition to generative artificial intelligence (“AI”) architecture. In an example, a targeted GPT may consider an aggregate of a current season, a current customer, a current life event and historical data. Such a targeted GPT may prompt a customer: We noticed a direct deposit into your account, would you like a portion of deposit routed to a different account?

A system for creating a targeted, generative, pre-trained, transformer model is provided. The system may include a processor. The processor may receive a pre-trained model. The pre-trained model may include a plurality of weighted neurons organized within a plurality of layers. The processor may receive an instruction to prune the pre-trained model for a predetermined field. The processor may identify a first set of one or more training data elements corresponding to the predetermined field. The processor may freeze the weights of the neurons of the pre-trained model. The processor may disable the first set of one or more training data elements from changing the weights of the neurons included in the pre-trained model.

The processor may process the first set of one or more training data elements through the pre-trained model. During the process, the processor may highlight a subset of neurons within the pre-trained model. The subset of neurons may be affected during the process of the first set of one or more training data elements. The processor may create a pruned, targeted, pre-trained model for the predetermined field. The pruned, targeted, pre-trained model may include the highlighted neurons and associated weights.

The pruned, targeted, pre-trained model may be absent a portion of the plurality of neurons which are unaffected during the process. The processor may tune the pruned, targeted, pre-trained model by processing a second set of one or more training data elements that correspond to the predetermined field. The processor may rebuild and regenerate neurons, at the pruned, targeted, pre-trained model, during process of the second set of one or more training data elements. The rebuilt and regenerated neurons may correspond to neurons included in the pre-trained model.

In some embodiments, the subset of neurons within the pre-trained model may be input into the pruned, targeted, pre-trained model after being affected more than a predetermined number of times. The predetermined number may be ten. The predetermined number may be three. The predetermined number may be any suitable number.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6 shows still another illustrative diagram in accordance with principles of the disclosure;

FIG. 7 shows yet another illustrative diagram in accordance with principles of the disclosure; and

FIG. 8 shows still yet another illustrative diagram in accordance with principles of the disclosure.

### DETAILED DESCRIPTION OF THE DISCLOSURE

Systems, apparatus and methods for creating targeted, generative, pre-trained, transformer models (also referred to herein as “targeted models”) from a generative, pre-trained, transformer model (also referred to herein as “pre-trained model”) are provided.

Methods may include receiving the pre-trained model. The pre-trained model may include a plurality of weighted neurons organized within a plurality of layers.

Methods may include pruning the pre-trained model for a specific discipline. A discipline may be a topic, such as finance, academia and technology. A discipline may be a subtopic, such as subtopics of finance. For example, a subtopic of finance may include student loans, retirement plans and car loans.

The pruning may include identifying one or more training data elements. The one or more training data elements may pertain, or relate, to the specific discipline.

The pruning may include processing the one or more training data elements through the pre-trained model. During the processing of the one or more training data elements, the method may include limiting the ability of the one or more training data elements to modify weights associated with the neurons.

It should be noted that processing of data elements, whether training data elements or production data elements, involves pushing the data elements through the neurons within the pre-trained model. While a data element is traversing the neural network (within the pre-trained model), the data element may navigate a subset of the neurons included in the neuron network. The subset of the neurons may relate to the data element. Each data element may traverse a distinct path of neurons within the neuron network.

Training data elements may be data elements that are used to train a model. As such, the training data elements may be able to modify the weights associated with the neurons. Training data elements may, in certain embodiments, be able to add additional neurons to a neural network. Training data elements may be labeled training data elements. Labeled training data elements may be data elements in which a label (or desired outcome of the model) is tagged to the data element. Training data elements may be unlabeled. Unlabeled training data elements may be data elements in which a label is not tagged to the data element. Production data elements may be data elements that are processed by the model to identify a result. Production data elements may be labeled or unlabeled.

Production data elements may be used in a production environment. It should be noted that many times the production data elements are also able to modify the weights within the neural network. As such, the neural network may be continually updating based on the newly input production data elements.

However, during the pruning process, the abilities of the data elements to modify the weights associated with the neurons may be limited, disabled or prevented. As such, the data elements may be unable to modify the weights associated with the neurons. This may be because a purpose of processing the training data elements associated with the specific discipline through the neural network is not to modify the pre-trained model but rather to identify neurons within the pre-trained model that correspond to (or relate to the same subject matter) as the training data elements associated with the specific discipline.

As such, during the processing, methods may include highlighting a plurality of affected neurons. Affected neurons may be identified as neurons which are included in a distinct processing path between the input and output neurons of the neural network (inclusive of the input and output neurons).

Methods may include creating a pruned copy of the pre-trained model. The pruned copy may be a targeted model for the specific discipline. The pruned copy may include the highlighted neurons and associated weights. The pruned copy may be absent a portion of the plurality of neurons which are unaffected during the processing. The portion of the plurality of neurons which are unaffected during the processing may be irrelevant to the specific discipline.

In certain embodiments, methods may include flagging each neuron affected by the plurality of neurons. Unflagged neurons may be removed from the plurality of neurons. The pruned copy may include the flagged neurons and associated weights.

In some embodiments, the one or more training data elements may be included in the plurality of training data elements. The plurality of training data elements may each affect a set of neurons. As such, methods may include highlighting the set of affected neurons from each of the plurality of training data elements. Methods may also include aggregating the highlighted sets of neurons into an aggregated list of neurons. Methods may also include tagging each neuron with a numerical value. The numerical value may be the number of times the neuron was affected. Methods may include identifying which neurons included in the aggregated list of neurons were affected over a predetermined threshold of times. The predetermined threshold of times may be identified as by more than a predetermined threshold number of training data elements. The predetermined threshold may be a percentage of times each neuron was affected when compared to the remaining neurons in the aggregated list. The predetermined threshold may be a number of times each neuron was affected when compared to the remaining neurons in the aggregated list. Methods may also include creating the pruned copy of the pre-trained model. The pruned copy may include the neurons that were affected over the predetermined threshold of times. In such embodiments, the pruned copy may not include all neurons affected by the training data elements. Rather, the pruned copy may include neurons that have been affected repeatedly during processing of the training data elements.

In certain embodiments, the plurality of training data elements each affect a set of neurons. Each set of affected neurons may be highlighted. The highlighted sets of affected neurons may be aggregated into a list of affected neurons. Each neuron within the list of affected neurons may be tagged with a numerical value. The numerical value may be the number of times the neuron was affected during processing the plurality of training data elements. Neurons which are tagged with a numerical value over a predetermined threshold may be included in the pruned copy. Neurons which are tagged with a numerical value below the predetermined threshold may be absent from the pruned copy.

The numerical value may be dynamic. For example, the numerical value may be initially set to fifty times. However, in the event that less than a predetermined number of neurons were affected over fifty times, the numerical value may be reset to twenty in order to have at least a minimum number of neurons within the pruned copy.

It should be noted that the predetermined threshold may be a number of times each neuron was affected. The number of times may be dynamic. The number of times may be based on a range of the numerical values tagged to the plurality of neurons.

At times, the predetermined threshold may be a normalized number. The numerical values of each neuron may be normalized into the normalized number. Neurons that have been tagged with a normalized number that is greater than the predetermined threshold may be included within the targeted model. Neurons that have been tagged with a normalized number that is less than the predetermined threshold may be absent from the targeted model.

In some embodiments, methods may include filtering inputs to the targeted model. Methods may include removing inputs that do not correspond over a threshold level of correspondence to the specific discipline.

In certain embodiments, methods may include receiving additional training data pertaining to the specific discipline. Methods may also include processing, in parallel, the additional training data through the pre-trained model and through the targeted model for the specific discipline.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

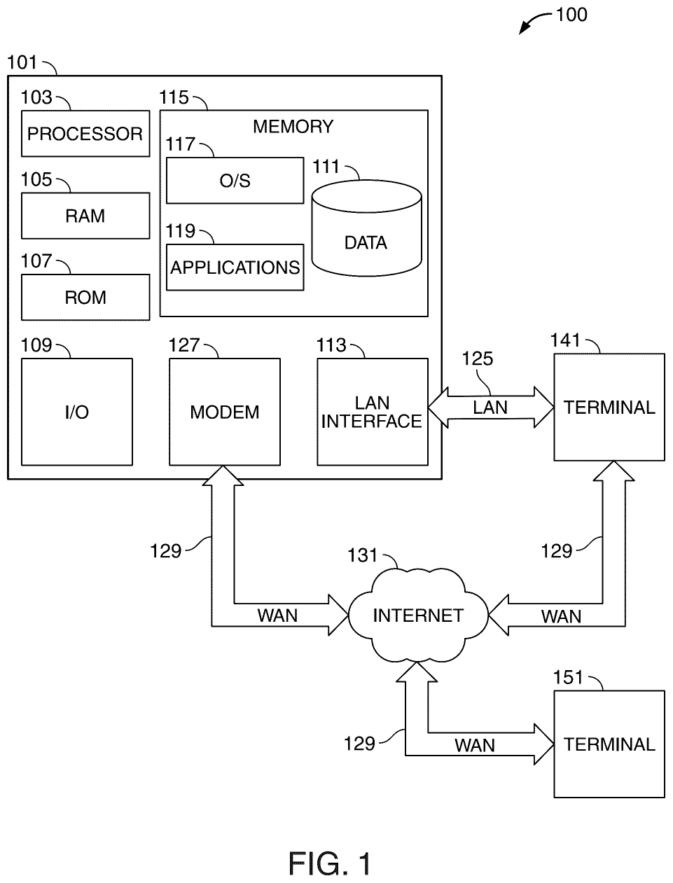

FIG. 1 shows an illustrative block diagram of system 100 that includes computer 101. Computer 101 may alternatively be referred to herein as an “engine,” “server,” or a “computing device. ” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

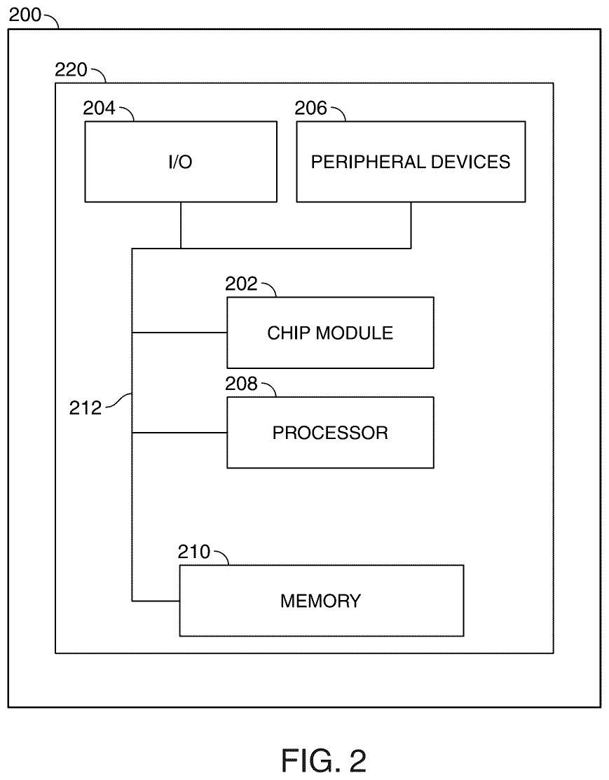

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

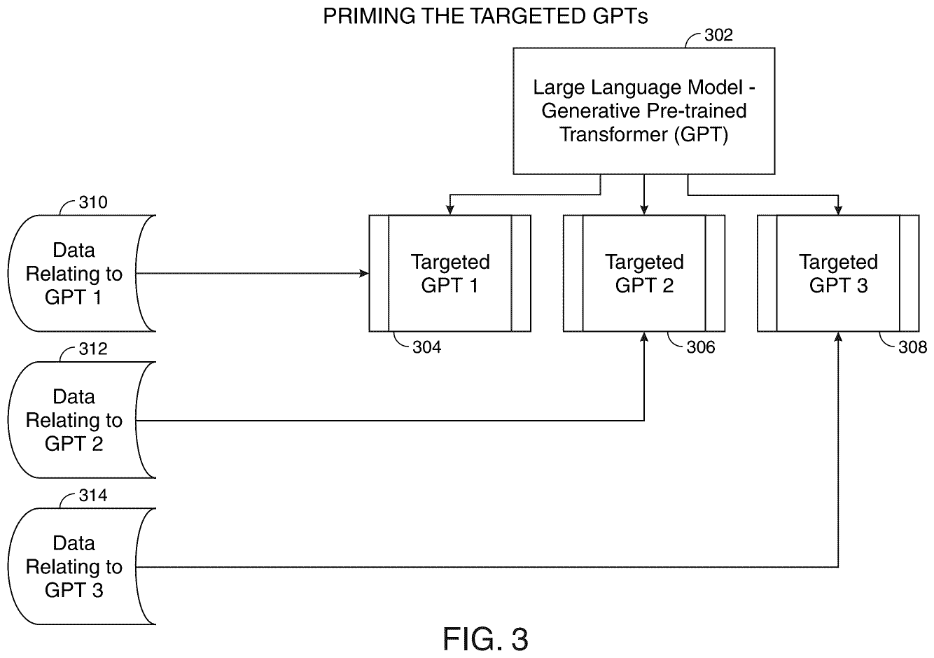

FIG. 3 shows an illustrative diagram. The illustrative diagram shows priming the targeted GPTs. Priming the targeted GPTs may involve instantiating one or more targeted GPTs for one or more specific disciplines. Priming the targeted GPTs may also involve assigning a specific discipline to a targeted GPT. Priming the targeted GPTs may also involve pushing training data relating to a specific discipline to the appropriate GPT in order to provide the GPT with proper training data.

Large language model 302 may be used as core for targeted GPT 1, shown at 304, targeted GPT 2, shown at 306 and targeted GPT 3, shown at 308. Each of GPTs 304, 306 and 308 may be further trained with training data specific to the discipline in which GPT 304, 306 or 308 is in the process of being specialized. As such, data, shown at 310, relating to a specific discipline in which GPT 1 is being specialized may be processed through targeted GPT 1. Data, shown at 312, relating to a specific discipline in which GPT 2 is being specialized may be processed through targeted GPT 2. Data, shown at 314, relating to a specific discipline in which GPT 3 is being specialized may be processed through targeted GPT 3. Processing data relating to GPT 1 (310) may train (reweight) the neurons included in GPT 1 for a specific discipline. Processing data relating to GPT 2 (312) may train (reweight) the neurons included in GPT 2 for a specific discipline. Processing data relating to GPT 3 (314) may train (reweight) the neurons included in GPT 3 for a specific discipline.

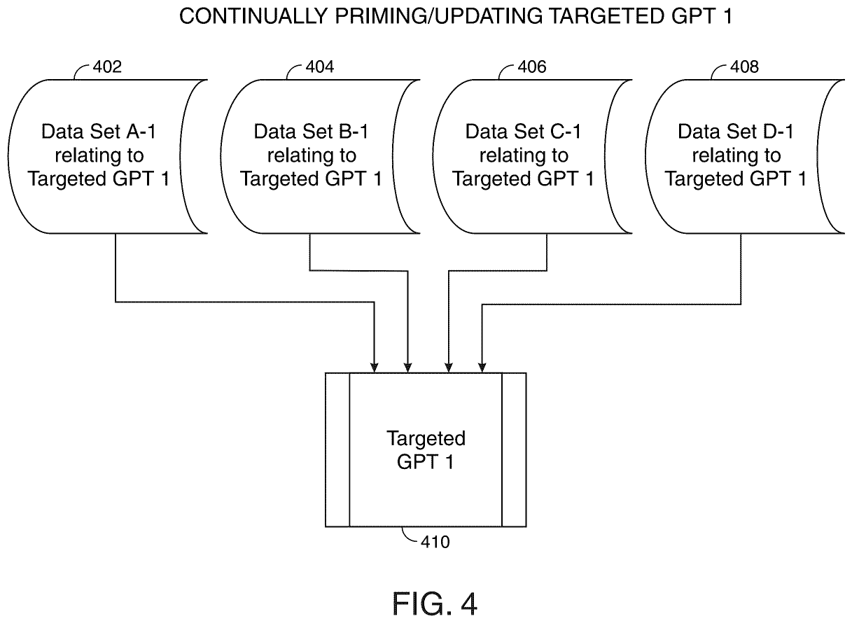

FIG. 4 shows an illustrative diagram. Targeted GPT 1, shown at 410, may be continually primed and/or updated. Data set A-1 relating to targeted GPT 1 (402), data set B-1 relating to targeted GPT 1 (404), data set C-1 relating to targeted GPT 1 (406) and data set D-1 relating to targeted GPT 1 (408) may be pushed to and/or retrieved from targeted GPT 1 to further train and focus targeted GPT 1. The continual priming and/or updating may be performed in a production environment. As such, one or more of data sets A-1, B-1, C-1 and D-1 may include production environment data.

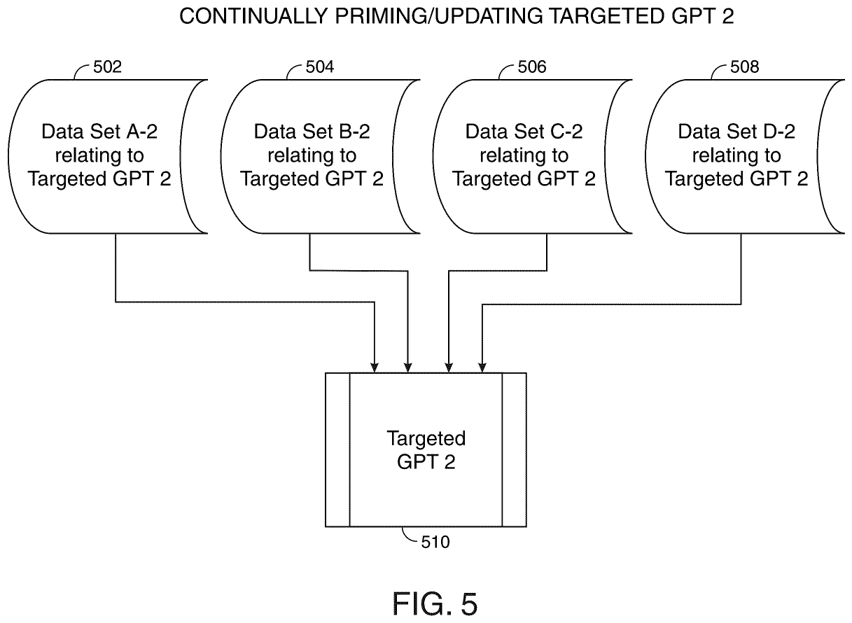

FIG. 5 shows an illustrative diagram. Targeted GPT 2, shown at 510, may be continually primed and/or updated. Data set A-2 relating to targeted GPT 2 (502), data set B-2 relating to targeted GPT 2 (504), data set C-1 relating to targeted GPT 2 (506) and data set D-1 relating to targeted GPT 2 (500) may be pushed to and/or retrieved from targeted GPT 2 to further train and focus targeted GPT 2. The continual priming and/or updating may be performed in a production environment. As such, one or more of data sets A-2, B-2, C-2 and D-2 may include production environment data.

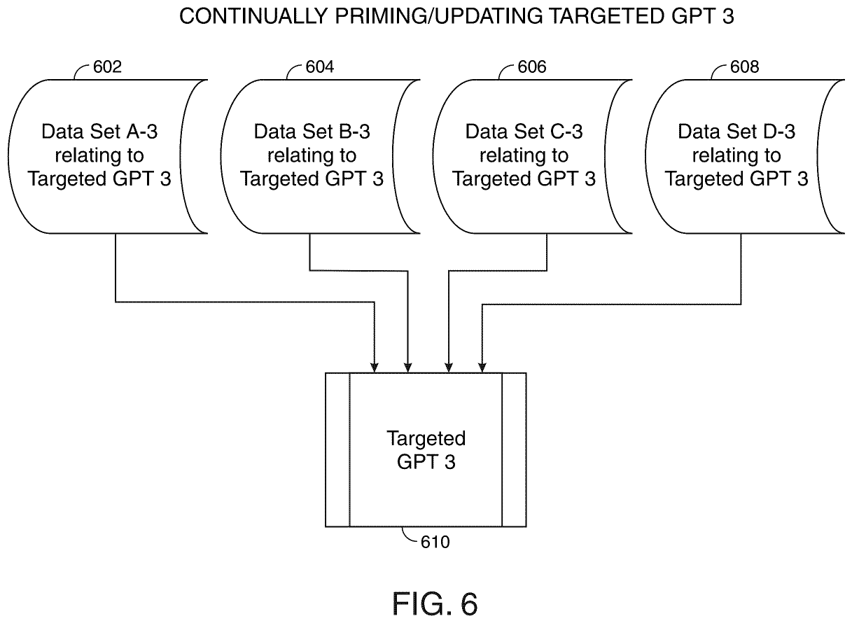

FIG. 6 shows an illustrative diagram. Targeted GPT 3, shown at 610, may be continually primed and/or updated. Data set A-3 relating to targeted GPT 3 (602), data set B-3 relating to targeted GPT 3 (604), data set C-3 relating to targeted GPT 3 (606) and data set D-3 relating to targeted GPT 3 (608) may be pushed to and/or retrieved from targeted GPT 3 to further train and focus targeted GPT 3. The continual priming and/or updating may be performed in a production environment. As such, one or more of data sets A-3, B-3, C-3 and D-3 may include production environment data.

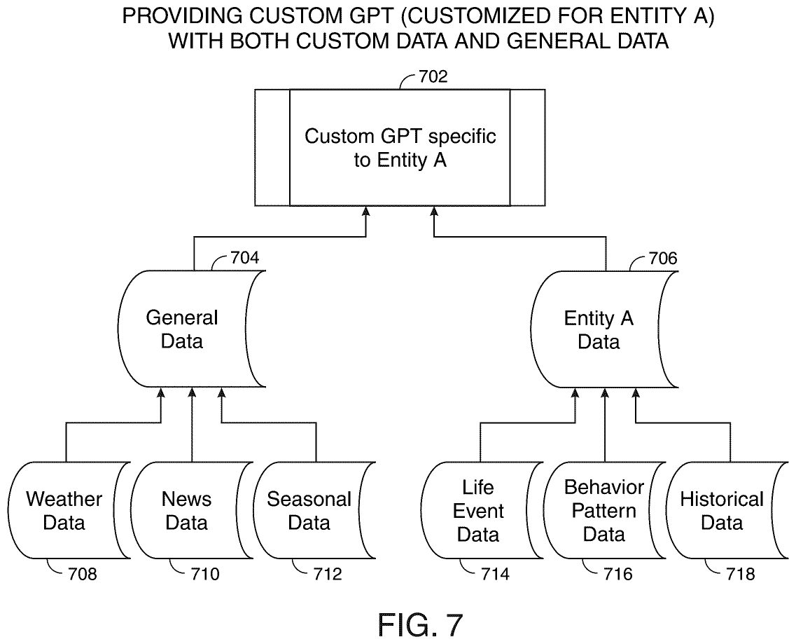

FIG. 7 shows an illustrative diagram. The illustrative diagram shows providing a custom GPT with both custom data and general data. The custom GPT may be customized for entity A. Custom GPT, shown at 702, may be customized for entity A. Custom GPT 702 may receive and/or retrieve data from general data 704 and/or entity A data 706. General data 704 may include weather data 708, news data 710 and seasonal data 712. Entity A data 706 may include life event data 714, behavior pattern data 716 and historical data 718.

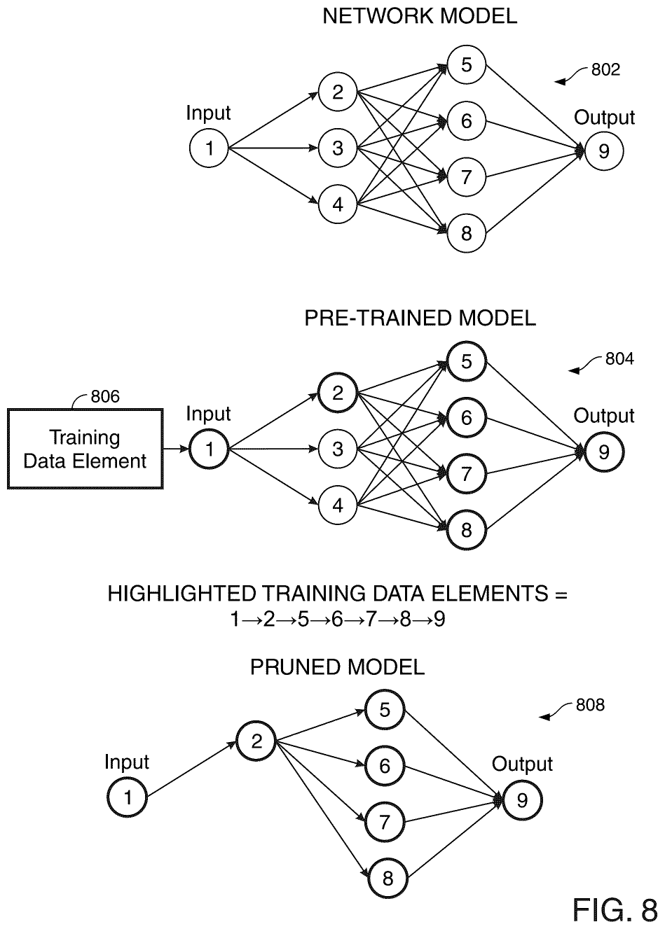

FIG. 8 shows an illustrative diagram. The illustrative diagram shows pruning a neural network. Network model 802 shows a neural network. The neural network may include a plurality of neurons. The plurality of neurons may be weighted.

Training data element 806 may be input into pre-trained model 804. Training data element 806 may be associated with a specific discipline. There may be a plurality of training data elements input into pre-trained model 804.

Pre-trained model 804 may include the same neurons shown in network model 802. When training data element 806 is pushed through pre-trained model 804, neurons 1, 2, 5, 6, 7, 8 and 9 may be affected. The affected neurons are shown in FIG. 8 as having a thicker border than the other neurons. These affected neurons may be referred to herein in the alternative as highlighted. The affected neurons may include neurons that have been reweighted in response to processing training data element 806. It should be noted that prior to processing training data element 806, pre-trained model 804 may have been frozen —i.e., a frozen pre-trained model may be understood to mean a model in which changes made to the weights of the neurons during processing are reverted back to original weights after processing the training element. A frozen pre-trained model may also be understood to mean a model in which changes are not made to the weights of the neurons during processing. A non-frozen model is also within the scope of this disclosure.

The highlighted neurons may be included in pruned model 808. Pruned model 808 may be specific to a discipline associated with training data element 806.

Thus, methods and apparatus for a TARGETED GENERATIVE PRE-TRAINED TRANSFORMERS (“GPTs”) are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for creating targeted, generative, pre-trained, transformer models (“targeted models”) from a generative, pre-trained, transformer model (“pre-trained model”), the method comprising:
receiving the pre-trained model, said pre-trained model comprising a plurality of weighted neurons organized within a plurality of layers;
pruning the pre-trained model for a specific discipline, the pruning comprising:
identifying one or more training data elements pertaining to the specific discipline;
processing the one or more training data elements through the pre-trained model, said processing limiting the ability of the one or more training data elements to modify the weights associated with the neurons;
during the processing, highlighting a plurality of affected neurons; and
creating a pruned copy of the pre-trained model, said pruned copy being a targeted model for the specific discipline, said pruned copy of the pre-trained model comprising the highlighted neurons and associated weights, said pruned copy absent a portion of the plurality of neurons which are unaffected during the processing.

2. The method of claim 1 further comprising:
filtering inputs to the targeted model; and
removing inputs that do not correspond, over a threshold level of correspondence, to the specific discipline.

3. The method of claim 1, wherein:
the one or more training data elements are included in a plurality of training data elements; and
the plurality of training data elements each affect a set of neurons;
the method further comprising:
highlighting the set of affected neurons from each of the plurality of training data elements;
aggregating the highlighted sets of neurons into an aggregated list of neurons;
tagging each neuron with a numerical value of a number of times the neuron was affected;
identifying which neurons included in the aggregated list of neurons were affected over a predetermined threshold of times; and
creating the pruned copy of the pre-trained model comprising the neurons that were affected over the predetermined threshold of times.

4. The method of claim 3, wherein the predetermined threshold is a percentage of times each neuron was affected when compared to the remaining neurons in the aggregated list.

5. The method of claim 3, wherein the predetermined threshold is a number of times each neuron was affected when compared to the remaining neurons in the aggregated list.

6. The method of claim 1, further comprising:
receiving additional training data pertaining to the specific discipline; and
processing, in parallel, the additional training data through the pre-trained model and through the targeted model for the specific discipline.

7. The method of claim 1 wherein the portion of the plurality of neurons which are unaffected during the processing are irrelevant to the specific discipline.

8. A method for creating targeted, generative, pre-trained, transformer models (“targeted models”) from a generative, pre-trained, transformer model (“pre-trained model”), the method comprising:
receiving a pre-trained model, said pre-trained model comprising a plurality of weighted neurons organized within a plurality of layers;
pruning the pre-trained model for a specific discipline, the pruning comprising:
identifying a plurality of training data elements pertaining to the specific discipline;
processing the plurality of training data elements through the pre-trained model;
during the processing, flagging each neuron affected by the plurality of training data elements; and
removing one or more neurons from the plurality of neurons, said one or more neurons being unflagged; and
creating a pruned copy of the pre-trained model, said pruned copy being a targeted model for the specific discipline, said pruned copy comprising the flagged neurons and associated weights, said pruned copy absent a portion of the pre-trained model's neurons which are unaffected during the processing.

9. The method of claim 8 further comprising:
filtering inputs to the targeted model; and
removing inputs that do not correspond, over a threshold level of correspondence, to the specific discipline.

10. The method of claim 8, wherein:
the plurality of training data elements each affect a set of neurons;
the method further comprising:
highlighting the set of neurons from each of the plurality of training data elements;
aggregating the highlighted sets of affected neurons into an aggregated list of affected neurons;
tagging each neuron with a numerical value, said numerical value being a number of times the neuron was affected during processing the plurality of training data elements;
identifying which neurons are tagged with a numerical value over a predetermined threshold; and
creating the pruned copy of the pre-trained model, said pruned copy comprising the neurons that were affected over the predetermined threshold of times.

11. The method of claim 10, wherein the predetermined threshold is a number of times each neuron was affected.

12. The method of claim 11, wherein the number of times is:
dynamic; and
based on a range of the numerical values tagged to the plurality of neurons.

13. The method of claim 10, wherein:
the predetermined threshold is a normalized number;
the numerical values of each neuron are normalized into the normalized number;
neurons that have been tagged with a normalized number that is greater than the predetermined threshold are included within the targeted model; and
neurons that have been tagged with a normalized number that is less than the predetermined threshold are absent from the targeted model.

14. The method of claim 8, further comprising:
receiving additional training data pertaining to the specific discipline; and
processing, in parallel, the additional training data through the pre-trained model and through the targeted model.

15. The method of claim 8 wherein the processing comprises preventing the plurality of training data elements from modifying the weights associated with the neurons.

16. A system for creating a targeted, generative, pre-trained, transformer model, the model comprising:
a processor, the processor is operable to:
receive a pre-trained model, the pre-trained model comprising a plurality of weighted neurons organized within a plurality of layers;
receive an instruction to prune the pre-trained model for a predetermined field;
identify a first set of one or more training data elements corresponding to the predetermined field;
freeze the weights of the neurons of the pre-trained model;
disable the first set of one or more training data elements from changing the weights of the neurons included in the pre-trained model;
process the first set of one or more training data elements through the pre-trained model;
during the process, highlight a subset of neurons within the pre-trained model, said subset of neurons affected during the process of the first set of one or more training data elements;
create a pruned, targeted, pre-trained model for the predetermined field, said pruned, targeted, pre-trained model comprising the highlighted neurons and associated weights, said pruned, targeted, pre-trained model absent a portion of the plurality of neurons which are unaffected during the process;
tune the pruned, targeted, pre-trained model by processing a second set of one or more training data elements that correspond to the predetermined field; and
rebuild and regenerate neurons, at the pruned, targeted, pre-trained model, during process of the second set of one or more training data elements.

17. The system of claim 16 wherein the rebuilt and regenerated neurons correspond to neurons included in the pre-trained model.

18. The system of claim 16, where the subset of neurons within the pre-trained are input into the pruned, targeted, pre-trained model after being affected more than a predetermined number of times.

19. The system of claim 18, wherein the predetermined number is ten.

20. The system of claim 19, wherein the predetermined number is three.
